(19) United States
(12) Patent Application Publication
(10) Pub. No.: US 2024/0248069 A1
(43) Pub. Date: Jul. 25, 2024

(54) AN ANALYZER SYSTEM

(71) Applicant: Roche Diagnostics Operations, Inc., Indianapolis, IN (US)

(72) Inventors: Adrian Sievers-Engler, München Süd (DE); Tibor Toth, München Süd (DE)

(21) Appl. No.: 18/566,548

(22) PCT Filed: May 31, 2022
(86) PCT No.: PCT/EP2022/064773

§ 371 Date: Dec. 1, 2023

(30) Foreign Application Priority Data
Jun. 1, 2021 (EP) 21177218.1

(51) Int. Cl. G01N 30/72; G01N 30/62

(52) U.S. Cl. CPC G01N 30/7266; G01N 2030/621

(57) ABSTRACT

An analyzer system (110) is disclosed. The analyzer system (110) comprises:
at least one mass spectrometry device (112) having at least one electrospray ion source nozzle (114);
at least one liquid supply (116), wherein the liquid supply (116) is configured for providing at least one liquid having at least one analyte;
at least one gas supply (118), wherein the gas supply (118) is configured for providing at least one gas; and
at least one dopand gas supply (120), wherein the dopand gas supply (120) is configured for providing at least one chemical dopand gas having at least one chemical dopand (122) to the analyte provided by the liquid supply (116);
   wherein the liquid supply (116) and the gas supply (118) are coupled to the mass spectrometry device (112) via the electrospray ion source nozzle (114), wherein the dopand gas supply (120) is connected to the gas supply (118).

### TECHNICAL FIELD

The invention relates to an analyzer system, a multiplexing analyzer system, a use of an analyzer system and a method for analyzing at least one analyte. The devices and methods may be applied for measuring a molecular mass or molecular mass to charge ratio of an analyte or fragments of the aforementioned analyte for the purpose of analyzing, i.e. identifying and quantifying the analyte. Specifically, the devices and methods may be applied for the analysis of biological molecules such as small biological molecules. Other applications, however, are also feasible.

### BACKGROUND ART

Electrospray ionization (ESI) is a technique used in mass spectrometry to produce ions using an electrospray in which a high voltage is applied to a liquid to create an aerosol. The liquid comprising one or more analytes of interest may be dispersed by electrospray into a fine aerosol.

Enhancement of a signal-to-noise ratio in mass spectrometric systems with an electrospray ion source prior or during to ionization can be performed or promoted by addition of chemical dopands capable of enhancing an electrospray process. Addition is usually done either as additive to the solvent or chromatography eluent (pre-column) respectively or by employment of a T-piece type mixer (post-column).

Li et al., Anal. Chem. 2014, 86, 331-335, describes a chemical-vapor-assisted electrospray ionization for increasing analyte signals in electrospray ionization mass spectrometry. Specifically, a chemical-vapor-assisted electrospray ionization (ESI) technique to improve the detection sensitivity of ESI mass spectrometry (MS) is reported. This technique involves introducing a chemical vapor into the sheath gas around the nano-ESI spray tip or through a tubing with its outlet placed close to the spray tip. A variety of chemical vapors were tested and found to have varying degrees of effects on analyte signal intensities. The use of benzyl alcohol vapors in ESI was found to increase signal intensities of standard peptides by up to 4-fold. When this technique was combined with capillary liquid chromatography tandem MS (LC-MS/MS), the number of unique peptides identified in the acid hydrolysate of alpha casein increased by 45% and the number of peptides and proteins identified in a tryptic digest of E. coli cell lysate increased by 13% and 14%, respectively, along with an increased average match score. This technique could also increase the analyte signals for some small molecules, such as phenylephrine, by up to 3-fold. The increased analyte signals observed in the chemical-vapor-assisted ESI process is related to the enhancement of the ionization efficiency in ESI. The method can be readily implemented to an existing ESI mass spectrometer at minimum cost for improving detection sensitivity.

In Badu-Tawiah et al., Analyst, 2017, 142, 2152-2160, a re-configurable, multi-mode contained electrospray ionization for protein folding and unfolding on the millisecond time scale is described. Specifically, a reconfigurable contained-electrospray (ES) ion source is described that can be operated in three unique modes (Types I, II and III) and was applied to control the charge state of proteins for subsequent online characterization by mass spectrometry. Using this device, proteins prepared in 100% water were highly charged after exposure to hydrochloric acid vapor. For myoglobin, the shift to a higher charge state occurred faster than the heme cofactor could escape the unfolding protein. This effect reflected in the detection of highly charged holo-myoglobin intermediates (+26), which suggests the modification process occurred on a millisecond time scale (Type I mode). By introducing a cavity in the contained-ES emitter (Type II mode), increased protein denaturation was observed where only apo-myoglobin ions were detected.

Similarly, US 2016/0329198 A1 describes apparatuses that can comprise an electrospray emitter comprising a sample capillary extending from a sample inlet to a sample outlet and an element comprising a conduit coaxially disposed around the electrospray emitter thereby forming a chamber extending between the conduit and the sample capillary and terminating in a gas outlet. The element can further comprise, in some examples, a carrier gas inlet fluidly connected to the chamber, and a working gas inlet fluidly connected to the chamber, wherein the chamber is configured to provide a path for fluid flow from the carrier gas inlet and the working gas inlet to the gas outlet. Also disclosed herein are methods of use of the apparatuses. In some examples discussed herein are methods and apparatuses for contained-electrospray, for example for use in mass spectrometry and/or droplet reactions.

Despite the advantages achieved by the above-mentioned devices, several technical challenges remain. Pre-column implementations commonly exert on column lifetime and restrain a chromatography method and/or a chromatography assay development by altering elution properties of the used solvents such as methanol, acetonitrile and/or water. Thus, there may be a severe impact on column performance and lifetime. When the electrospray ionization technique is combined with liquid chromatography (LC) such as high-performance liquid chromatography (HPLC) or ultra-high performance liquid chromatography (UHPLC), post column implementations are typically not feasible, specifically due to adverse effects on separation and analytical peak shape signal overlap. This effect may specifically be even more aggravated with liquid chromatographic techniques that commonly use low flow rates such as in the microliter/min range or in the nanoliter/min range. These liquid chromatographic techniques may specifically include capillary liquid chromatography techniques (cLC, capillary LC, CapLC) and/or nano scale liquid chromatography techniques (NanoLC). Due to excessive peak broadening, post column implementations commonly introduce unwanted dwell volumes which are generally unfeasible for usage with such low flow rates. Furthermore, with post-column dopand addition into liquid chromatography flowpaths such as by a T-piece capillary connector, dopand clearance of downstream liquid chromatography flowpath for assays negatively susceptible to aforementioned dopands and general carry-over concerns arise. This may specifically be the case in a fully integrated, random access automated chromatography and/or mass spectrometry clinical analyzer with frequent changes of chromatographic conditions and targeted analytes.

### Problem to be Solved

It is therefore desirable to provide an analyzer system, a multiplexing analyzer system, a use of an analyzer system and a method for analyzing at least one analyte which at least partially address the above-mentioned technical challenges. Specifically, it is desirable to increase the signal-to-noise ratio of analyte signals acquired by the analyzer system.

### SUMMARY

This problem is addressed by an analyzer system, a multiplexing analyzer system, a use of an analyzer system and a method for analyzing at least one analyte with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, an analyzer system is disclosed. The analyzer system comprises at least one mass spectrometry device having at least one electrospray ion source nozzle. Further, the analyzer system comprises at least one liquid supply. The liquid supply is configured for providing at least one liquid having at least one analyte. Further, the analyzer system comprises at least one gas supply. The gas supply is configured for providing at least one gas. Further, the analyzer system comprises at least one dopand gas supply. The dopand gas supply is configured for providing at least one chemical dopand gas having at least one chemical dopand to the analyte provided by the liquid supply. The liquid supply and the gas supply are coupled to the mass spectrometry device via the electrospray ion source nozzle and the dopand gas supply is connected to the gas supply.

The term “analyzer system” as used herein is a broad term and is to be given its ordinary and customary meaning to a person of ordinary skill in the art and is not to be limited to a special or customized meaning. The term specifically may refer, without limitation, to an arbitrary system configured for carrying out at least one analytical measurement with at least one sample or at least one component of the sample. As a result of the measurement or as part of the measurement the analyzer system may generate at least one measurement result characteristic for the sample and/or the at least one component, specifically at least one measurement result regarding the analyte. In particular, analyte-related information regarding the analyzed sample may be derived or may be derivable from the analytical measurement. The information may e.g. regard the presence, the absence, the concentration or the amount of analyte present in the sample. In particular, the analyzer system may be configured for detecting the analyte in the sample. Specifically, the analyzer system may be an in vitro diagnostic analyzer. The term “in vitro diagnostic analyzer” as used herein is a broad term and is to be given its ordinary and customary meaning to a person of ordinary skill in the art and is not to be limited to a special or customized meaning. The term specifically may refer, without limitation, to an arbitrary analyzer system which is configured for carrying out at least one analytical measurement with at least one sample or at least one component of the sample which has been taken from a human or animal body. Specifically, the sample may be or may comprise blood, tissue or components thereof. Further, the sample may be or may comprise other body fluids or excretions or components thereof. Specifically the sample may comprise hairs, urine or feces. The in vitro diagnostic analyzer may be configured for detecting diseases or other conditions, and may be configured for monitoring an overall health to help cure, treat, or prevent diseases

As outlined above, the analyzer system comprises the at least one mass spectrometry device. The term “mass spectrometry device” as used herein is a broad term and is to be given its ordinary and customary meaning to a person of ordinary skill in the art and is not to be limited to a special or customized meaning. The term specifically may refer, without limitation, to an arbitrary analytical technique which is configured for measuring a mass-to-charge ratio of ions. Measurement results may specifically be presented as a mass spectrum, e.g. a plot of intensity as a function of the mass-to-charge ratio. As outlined above, the mass spectrometry device comprises the at least one electrospray ion source nozzle which may further be described below in more detail. Further, the mass spectrometry device may comprise at least one mass analyzer and at least one detector. The electrospray ion source nozzle, the mass analyzer and the detector may be arranged in an ionization chamber. The mass analyzer may be configured for sorting and separating ions according to their mass to charge ratio. The mass spectrometry device may comprise one or more ion optics components such as electromagnetic elements like a skimmer, a focusing lens, or multipoles. The ion optics components may be configured for transferring ions to a region within the ionization chamber where the mass analyzer is arranged.

The term “electrospray ion source nozzle” as used herein is a broad term and is to be given its ordinary and customary meaning to a person of ordinary skill in the art and is not to be limited to a special or customized meaning. The term specifically may refer, without limitation, to an arbitrary device which is configured for dispersing a liquid into a fine aerosol by employing electricity. The electrospray ion source nozzle may comprise at least one capillary. The capillary may exemplarily be made of glass and/or at least one metal such as stainless steel. The capillary may have an inner diameter of 0.05 mm to 0.5 mm, preferably of 0.1 mm to 0.3 mm. Also other dimensions may be feasible. The electrospray ion source nozzle may be configured to apply a high voltage on an outer surface of the capillary. The outer surface may have an electrical contact for applying the high voltage. Exemplarily, the electrical contact may be an electrically conducting coating on the outer surface of the capillary. The electrically conducting coating may exemplarily be a gold film, specifically a sputtered gold film. The high voltage may specifically be in the range of 0.1 kV to 10 kV, specifically of 0.5 kV to 7 kV. The electrospray ion source nozzle may be configured for generating an electric field which causes a dispersion of the liquid into an aerosol. The aerosol may comprise charged droplets.

The term “liquid supply” as used herein is a broad term and is to be given its ordinary and customary meaning to a person of ordinary skill in the art and is not to be limited to a special or customized meaning. The term specifically may refer, without limitation, to an arbitrary device which is configured to provide at least one liquid. Specifically, the liquid supply may comprise at least one storage element such as a flask or a container configured for providing the liquid and, specifically, for storing the liquid. Further, additionally or alternatively, the liquid supply may comprise at least one tube such as at least one hose. The tube may be configured for transferring the liquid to a desired place or for transferring the liquid to another element. Specifically, the electrospray ion source nozzle may comprise the at least one capillary. For further details, reference is made to the description above. As outlined above, the liquid supply and the gas supply are coupled to the mass spectrometry device via the electrospray ion source nozzle. Specifically, the liquid supply may comprise the at least one tube and the tube may be connected or may be connectable to the capillary of the electrospray ion source nozzle. The liquid supply may be configured for providing the liquid to the capillary of the electrospray ion source nozzle, specifically via the tube.

Specifically, the liquid supply may comprise at least one liquid supply dosing device such as a liquid supply syringe pump which may be configured for dosing a flow of the liquid having the at least one analyte into the capillary of the electrospray ion source nozzle. The liquid supply dosing device, specifically the liquid supply syringe pump, may be configured for dosing the flow of the liquid having the at least one analyte into the capillary of the electrospray ion source nozzle with a flow rate in the range of 1 nl/min to 50 μL/min.

Specifically, the analyzer system may comprise at least one liquid chromatography device. The term “liquid chromatography device” as used herein is a broad term and is to be given its ordinary and customary meaning to a person of ordinary skill in the art and is not to be limited to a special or customized meaning. The term specifically may refer, without limitation, to an arbitrary device which is configured for separating constituents of a mixture from one another. The mixture may be dissolved in a fluid which may also be referred to as mobile phase. The mobile phase may be configured to carry the mixture through a system such as a column, a capillary tube, a plate, or a sheet having a material which may also be referred to as stationary phase. The different constituents of the mixture may have different affinities for the stationary phase. Depending on interactions with the stationary phase, the different constituents of the mixture may travel with different velocities in the mobile phase which may lead to a separation of the different constituents from each other. The liquid chromatography device may be selected from the group consisting of a nano-liquid chromatography device, a micro-liquid chromatography device, a rapid liquid chromatography device, a high-performance liquid chromatography device. However, also other kinds of liquid chromatography devices may be feasible. Specifically, the liquid supply may correspond to the liquid chromatography device. Further, alternatively, the liquid supply may be coupled or couplable to the liquid chromatography device such as via at least one tube or the like. Thus, the liquid chromatography device may be configured for providing the liquid to the liquid supply.

The term “liquid” as used herein is a broad term and is to be given its ordinary and customary meaning to a person of ordinary skill in the art and is not to be limited to a special or customized meaning. The term specifically may refer, without limitation, to an arbitrary substance having a liquid state of aggregation. Specifically, the liquid may be a nearly incompressible fluid which conforms to a shape of its container but retains a, at least almost, constant volume independent of pressure. The liquid may specifically be selected from the group consisting of: water, specifically deionized water; an organic solvent; a buffer. Further, the liquid may comprise the at least one analyte as outlined above. The term “analyte” as used herein is a broad term and is to be given its ordinary and customary meaning to a person of ordinary skill in the art and is not to be limited to a special or customized meaning. The term specifically may refer, without limitation, to an arbitrary chemical or biological substance or species, such as a molecule or a chemical compound, to be detected and/or measured. Specifically, a presence, an absence, a concentration and/or an amount of the analyte in a sample may be detected or measured. Specifically, the analyte may be a biological molecule or macromolecule. The analyte may specifically be a steroid or a metabolite thereof, specifically estradiol. The analyte may further be selected from the group consisting of: a therapeutically active substance, specifically an antibiotic, specifically an anesthetic; a peptide; a protein; an endogenous metabolite, specifically a nucleotide; a lipid, specifically a phospholipid, specifically a ceramide, specifically a diacylglyceride, specifically a triacylglycieride, specifically a related compound comprising fatty acids; a toxin; a toxic compound; an exogenous compound; a saccharide, specifically a monosaccharide, specifically a disaccharide, specifically an oligosaccharide, specifically a polysaccharide, specifically a related compound thereof. Also, the analyte may be a metabolite of aforementioned compounds. However, also other analytes may be feasible.

The term “gas supply” as used herein is a broad term and is to be given its ordinary and customary meaning to a person of ordinary skill in the art and is not to be limited to a special or customized meaning. The term specifically may refer, without limitation, to an arbitrary device which is configured to provide at least one gas. Specifically, the gas supply may comprise at least one storage element such as a flask or a container configured for providing the gas and, specifically, for storing the gas. Further, specifically, the gas supply may comprise at least one gas generator. Further, additionally or alternatively, the gas supply may comprise at least one tube such as at least one hose. The tube may be configured for transferring the gas to a desired place or for transferring the gas to another element. Specifically, as outlined above, the electrospray ion source nozzle may comprise the at least one capillary. For further details, reference is made to the description above. As outlined above, the liquid supply and the gas supply are coupled to the mass spectrometry device via the electrospray ion source nozzle. The gas supply may comprise the at least one tube and the tube may lead to an end or to a tip of the capillary or to a region near the end or the tip of the capillary. Specifically, the gas supply may comprise at least one gas supply dosing device such as a gas supply syringe pump configured for dosing a flow of the gas through the tube. The term “gas” as used herein is a broad term and is to be given its ordinary and customary meaning to a person of ordinary skill in the art and is not to be limited to a special or customized meaning. The term specifically may refer, without limitation, to an arbitrary substance having a gaseous state of aggregation. Particles of the gas may move freely at a large distance from one another and may evenly fill an available space.

Specifically, the gas supply may be a nebulizer gas supply. The nebulizer gas supply may be configured for providing at least one nebulizer gas. The nebulizer gas may be configured for nebulizing the liquid provided by the liquid supply. Specifically, the nebulizer gas may be configured for supporting a dispersing of a liquid into a fine aerosol. Further, the nebulizer gas may be configured for supporting a transfer of the fine aerosol from the capillary towards the mass analyzer. Specifically, the nebulizer gas may comprise at least one inert gas, specifically at least one of nitrogen, argon, helium. Further, the nebulizer gas may comprise mixtures of at least one of nitrogen, argon, helium with oxygen. Further, specifically, the nebulizer gas may comprise oil free compressed zero grade air. The nebulizer gas supply may also be referred to as sheath gas supply.

Further, optionally, the analyzer system may comprise at least one heated gas supply. The the heated gas supply may be configured for providing at least one heated gas to the electrospray ion source nozzle. The heated gas may have a temperature which is higher than a temperature of an environment of the heated gas supply. Specifically, the heated gas may have a temperature in the range of 20° C. to 800° C., specifically of 25° C. to 700° C. Specifically, the heated gas may comprise at least one inert gas, specifically at least one of nitrogen, argon, helium. Further, the heated gas may comprise mixtures of at least one of nitrogen, argon, helium with oxygen. Further, specifically, the heated gas may comprise oil free compressed zero grade air. Further, the heated gas may be oil-free compressed air. Also other kinds of gasses may be feasible. The heated gas supply may comprise at least one storage element such as a flask or a container configured for providing the heated gas and, specifically, for storing the gas. Further, additionally or alternatively, the heated gas supply may comprise at least one tube such as at least one hose. Further, the heated gas supply may comprise at least one heating element. Specifically, the heating element may be configured for heating gas by natural or forced convection, by swirling and/or by circulating the gas. The heating element may be configured for heating gas up to a desired temperature. Specifically, the heated gas supply may comprise at least one pipeline and the heating element may be configured for directly or indirectly heating the gas in the pipeline, wherein the gas may be stationary or circulating. The heating element may be in direct contact with the gas or may be configured for heating the gas through a protective tube. The heating element may specifically be selected from the group consisting of: a ring radiator, a flange radiator. Also other embodiments may be feasible.

Exemplarily, the analyzer system may comprise the nebulizer gas supply and the heated gas supply wherein the nebulizer gas supply corresponds to the gas supply as outlined above. Thus, the dopand gas supply may be connected to the nebulizer gas supply. Further, exemplarily, the analyzer system may comprise the nebulizer gas supply and the heated gas supply wherein the heated gas supply corresponds to the gas supply as outlined above. Thus, the dopand gas supply may be connected to the heated gas supply. Further, exemplarily, the analyzer system may comprise only the nebulizer gas supply and may not comprise the heated gas supply wherein the nebulizer gas supply corresponds to the gas supply as outlined above.

The term “dopand gas supply” as used herein is a broad term and is to be given its ordinary and customary meaning to a person of ordinary skill in the art and is not to be limited to a special or customized meaning. The term specifically may refer, without limitation, to an arbitrary device which is configured for providing at least one chemical dopand gas. Specifically, the dopand gas supply may comprise at least one storage element such as a flask or a container configured for providing the chemical dopand gas and, specifically, for storing the chemical dopand or for storing at least one raw material for the chemical dopand. The chemical dopand or the raw material for the chemical dopand may be stored in the dopand gas supply in a gaseous state. Further, the chemical dopand or the raw material for the chemical dopand may be stored in the dopand gas supply in a solid state or in a liquid state. Further details on embodiments of the dopand gas supply will be given below in more detail.

The term “chemical dopand gas” as used herein is a broad term and is to be given its ordinary and customary meaning to a person of ordinary skill in the art and is not to be limited to a special or customized meaning. The term specifically may refer, without limitation, to an arbitrary gas comprising as least one chemical dopand. The chemical dopand may be configured for enhancing a signal-to-noise-ratio of a measurement conducted with the analyzer system such as by increasing a signal of the analyte, by suppressing background signals. Specifically, the chemical dopand gas may be configured for supporting a protonation or a deprotonation of the analyte. Thus, the chemical dopand gas may comprise at least component which may, in turn, deprotonate or protonate. Specifically, the chemical dopand gas may be ammonia. Ammonia may be configured for protonating the analyte. At least one raw material for a formation of the chemical dopand gas may be selected from the group consisting of: ammonium carbonate, ammonium fluoride, ammonium acetate, ammonium methanoate. Further, the at least one raw material for the formation of the chemical dopand gas may comprise other compounds capable of dissociating into or releasing ammonia gas.

As outlined above, the dopand gas supply is connected to the gas supply. Specifically, the dopand gas supply may be connected to the nebulizer gas supply or to the heated gas supply. Specifically, the analyzer system may comprise at least one supply line such as at least one tube. The supply line may be configured for connecting the at least one container of the gas supply to the electrospray ion source nozzle, specifically to the capillary. The dopand gas supply may specifically be connected to the supply line of the gas supply. More specifically, the dopand gas supply may comprise at least one dopand gas supply line such as at least one dopand gas supply tube. The dopand gas supply line may be connected to the supply line of the gas supply. Exemplarily, the dopand gas supply line may be connected to the supply line of the gas supply via at least one connecting element such as via at least one valve or via at least one t-piece. Further, the supply line of the gas supply may comprise at least one inlet which may be configured for transferring gas from the supply line of the gas supply into the dopand gas supply. Moreover, the supply line of the gas supply may comprise at least one outlet which may be configured for transferring gas from the dopand gas supply into the supply line of the gas supply. A plurality of other options may exist. Further, the dopand gas supply line may comprise at least one dopand gas dosing device such as a syringe pump configured for dosing a flow of the chemical dopand gas from the dopand gas supply into the gas supply. Exemplarily, the dopand gas dosing device may be integrated into the dopand gas supply line. Further, exemplarily, the dopand gas dosing device may be integrated into the outlet of the gas supply line. Specifically, the dopand gas dosing device may be configured for adapting a concentration of the chemical dopand to a gradient of the liquid chromatography device. Further, the dopand gas dosing device may be configured for adapting the concentration of the chemical dopand to a changing ionization efficiency.

Specifically, the gas supply and the dopand gas supply may be arranged sequentially. Further, specifically, the gas supply, the dopand gas supply and the liquid supply may be arranged sequentially. Exemplarily, the dopand gas supply and optionally also the liquid supply may respectively be connected to the supply line of the gas supply. The term “sequential arrangement” as used herein is a broad term and is to be given its ordinary and customary meaning to a person of ordinary skill in the art and is not to be limited to a special or customized meaning. The term specifically may refer, without limitation, to an arrangement in series without any branches. Thus, there may be a serial connection of the gas supply and the dopand gas supply or of the gas supply, the dopand gas supply and the liquid supply, specifically in such a way that a single flow path is formed.

The dopand gas supply may comprise at least one dopand gas flask comprising the chemical dopand gas. The term “dopand gas flask” as used herein is a broad term and is to be given its ordinary and customary meaning to a person of ordinary skill in the art and is not to be limited to a special or customized meaning. The term specifically may refer, without limitation, to an arbitrary flask which may be configured for storing and providing a gas, specifically a chemical dopand gas. The dopand gas flask may also be referred to as dopand gas flask bottle. The flask may specifically be a pressure stable bottle. Further, the flask may specifically be made of glass. Specifically, the dopand gas flask may comprise the chemical dopand as pressurized gas. The dopand gas flask may be connected or may be connectable to the gas supply. The gas supply may specifically be the nebulizer gas supply or may be the heated gas supply. Specifically, the dopand gas flask may be connected or may be connectable to the gas supply via at least one connection element such as at least one t-piece. Specifically, at least one gas supply tube of the gas supply and at least one tube being connected or connectable to the dopand gas flask may be connected or connectable to each other via the at least one t-piece. Further, the dopand gas supply may comprise at least one flow regulating element such as at least one valve. The flow regulating element, specifically the valve, may be configured for regulating a flow of the chemical dopand into the gas supply. The valve may also be referred to as gas regulator valve.

Further, the dopand gas supply may comprise at least one headspace gas extraction device. The term “headspace gas extraction device” as used herein is a broad term and is to be given its ordinary and customary meaning to a person of ordinary skill in the art and is not to be limited to a special or customized meaning. The term specifically may refer, without limitation, to an arbitrary container, specifically a sealed or sealable container, which is configured to provide a gas. Specifically, the container may be configured for receiving at least one substance, specifically at least one volatile substance, which may be in gaseous state or which may be brought in gaseous state as will further be described below in more detail. The gas may be available in a headspace of the container, e.g. in an upper region of the container and may be taken from the headspace and transferred to another device. Specifically, the headspace gas extraction device may be configured for providing the chemical dopand gas.

The headspace gas extraction device may be connected or may be connectable to the gas supply. Specifically, the analyzer system may comprise the at least one supply line. The supply line may be configured for supplying gas from the gas supply to the headspace gas extraction device. Further, the analyzer system may comprise at least one further supply line for supplying gas from the headspace gas extraction device to the gas supply. The supply line and the further supply line may specifically be or comprise one or more tubes. The supply line may also be referred to as inlet and the further supply line may also be referred to as outlet.

The headspace gas extraction device may specifically comprise at least one solution of the chemical dopand or may be configured for receiving the at least one solution of the chemical dopand. The solution of the chemical dopand may specifically be a volatile solution. The headspace gas extraction device may be configured for extracting the chemical dopand in gaseous form from a gas headspace. The headspace gas extraction device may be configured for impinging the gas of the gas supply with the chemical dopand such as via the further supply line as described above.

Further, the headspace gas extraction device may comprise at least one reaction vessel. The term “reaction vessel” as used herein is a broad term and is to be given its ordinary and customary meaning to a person of ordinary skill in the art and is not to be limited to a special or customized meaning. The term specifically may refer, without limitation, to an arbitrary device which is configured for receiving and holding at least one substance, specifically at least one liquid substance, and for enabling a reaction within the device, such as within at least one interior space of the device. The at least one substance, specifically the at least one liquid substance, may be configured for undergoing a chemical reaction with at least one further substance. Thus, the chemical dopand gas may be generated it situ by reaction, specifically by reaction of the at least one substance, specifically of at least one ammonia salt with a solution, specifically with a solution of sodium or potassium hydroxide. The reaction vessel may have an arbitrary shape. Specifically, the reaction vessel may be configured for receiving at least one ammonium salt. The headspace gas extraction device may further comprise at least one reaction vessel supply to the reaction vessel. The reaction vessel supply may specifically comprise at least one reaction vessel supply line or at least one reaction vessel tube. The reaction vessel supply may be configured for providing at least one reaction solution to the reaction vessel. The ammonium salt may be configured for undergoing a chemical reaction with the reaction solution. The ammonia salt may be selected from the group consisting of: ammonium sulfate, ammonium nitrate, ammonium methanoate, ammonium acetate, ammonium carbonate. However, also other kinds of ammonia salt may be feasible. Further, the reaction solution may be selected from the group consisting of: a solution of sodium hydroxide; a solution of potassium hydroxide. However, also other reaction solutions may be feasible. A concentration of the reaction solution may be in the range of 0.1 mol/l to 20 mol/l, specifically 0.5 mol/l to 15 mol/l, more specifically 1 mol/l to 11 mol/l. Specifically, a low concentration of the reaction solution may increase an operator safety. Further, specifically, a high concentration may increase a gas output.

Further, the analyzer system may comprise at least one pump, specifically at least one syringe pump, more specifically at least one motorized syringe pump. The reaction vessel supply may comprise the at least one pump, specifically the at least one syringe pump. The pump may be configured for transferring the reaction solution and for dosing a flow of the reaction solution into the reaction vessel. The analyzer system may further comprise at least one three-way valve. The three-way valve may be configured for electively connecting the syringe pump to the reaction vessel and to the gas supply. During reaction, the syringe pump may be connected to the reaction vessel and may be configured to be filled with a chemical dopand gas. After reaction, the syringe pump may be connected to the gas supply and may be configured for providing the chemical dopand gas to the gas supply. The analyzer system may further comprise at least one pressure regulator valve. The pressure regulator valve may refer to a valve which is configured for controlling a pressure of a fluid or gas to a desired value. The pressure regulator valve may specifically be an integral device with a pressure setting, a restrictor and/or a pressure sensor. Specifically, the pressure regulator valve may be a pressure reduction regulator. The pressure reducing regulator may be a control valve which is configured for reducing an input pressure of a fluid or gas to a desired value at its output. Further, specifically, the pressure regulator valve may be a back-pressure regulator. The back-pressure regulator may be a control valve which is configured for maintaining a set pressure at its inlet side by opening to allow flow when an inlet pressure exceeds the set value. The pressure regulator valve may connect the syringe pump to the gas supply. The headspace gas extraction device may be connected to the syringe pump via at least one three-way-valve. The syringe pump may be configured to be filled with a chemical dopand gas during reaction. Further, the chemical dopand may be provided as solid or liquid substance and the headspace gas extraction device may be configured for impinging the solid or liquid substance with the gas of the gas supply. Specifically, the chemical dopand gas may be released from a liquid solution of the dopand gas or, alternatively, may be released from an amenable solid or liquid such as either by releasing evaporating physical bound or adsorbed gas or by chemical decomposition of a precursor chemical. The solid substance may specifically be selected from the group consisting of: ammonium methanoate, ammonium acetate, ammonium carbonate. However, also other kinds of solid substances may be feasible. The headspace gas extraction device may specifically comprise at least one gas heating unit. The gas heating unit may be configured for heating the gas provided by the gas supply before the gas is impinged on the solid substance. The gas heating unit may specifically be configured for heating the gas provided by the gas supply to a temperature in the range of 50° ° C. to 500° ° C., specifically in the range of 100° C. to 400° C. The gas heating unit may be configured for heating gas by natural or forced convection, by swirling and/or by circulating the gas. The gas heating unit may be configured for heating gas up to a desired temperature. Specifically, the headspace gas extraction device may comprise at least one pipeline and the gas heating unit may be configured for directly or indirectly heating the gas in the pipeline, wherein the gas may be stationary or circulating. The gas heating unit may be in direct contact with the gas or may be configured for heating the gas through a protective tube. The gas heating unit may specifically be selected from the group consisting of: a ring radiator, a flange radiator. Also other embodiments may be feasible. Additionally or alternatively, the vessel may comprise at least one vessel heating element. The vessel heating element may be configured for heating the reaction vessel.

Further, the headspace gas extraction device may comprise at least one laser ablation device. The laser ablation device may be configured for ablating the solid substance. The term “laser ablation device” as used herein is a broad term and is to be given its ordinary and customary meaning to a person of ordinary skill in the art and is not to be limited to a special or customized meaning. The term specifically may refer, without limitation, to an arbitrary device which is configured for removing material from a surface, specifically a solid surface, by irradiating the surface with a laser beam. Specifically the material may be heated by absorbed laser energy and may evaporate or sublimate. However, further, the material may be converted to a plasma. Specifically, the laser ablation device may comprise a pulsed laser. However, also other embodiments may be feasible.

Also other embodiments of the dopand gas supply may be feasible. Exemplarily, the dopand gas supply may comprise at least one bubbling extraction device. The bubbling extraction device may be configured for extracting the chemical dopand gas from a liquid solution. The term “bubbling extraction device” as used herein is a broad term and is to be given its ordinary and customary meaning to a person of ordinary skill in the art and is not to be limited to a special or customized meaning. The term specifically may refer, without limitation, to an arbitrary container, specifically a sealed or sealable container, which is configured to provide a liquid. The liquid may comprise the chemical dopand. The bubbling extraction device may be connected or may be connectable to the gas supply as outlined above. Specifically, as outlined above, the analyzer system may comprise the at least one supply line. The supply line may be configured for supplying gas from the gas supply into the bubbling extraction device, specifically into the liquid provided by the container of the bubbling extracting device. Thus, the chemical dopand may be brought in gaseous state.

Specifically, the analyzer system may further comprise at least one storage tank, specifically at least one storage pressure tank. The term “storage pressure tank” may refer to an arbitrary container which is configured for holding gases or liquids at a pressure which differs from a pressure of the ambient atmosphere. The storage pressure tank may be configured for storing the gas comprising the chemical dopand in gaseous form. The storage pressure tank may be connected or connectable to a tube of the gas supply, specifically of the nebulizer gas supply. Further, the analyzer system may comprise at least one dosage gas regulator. The dosage gas regulator may be configured for connecting the gas supply to the storage pressure tank. Further, the analyzer system may comprise at least one compressor unit configured for compressing the gas comprising the chemical dopand in gaseous form. The term “compressor unit” may refer to an arbitrary mechanical device which is configured for increasing a pressure of a gas by reducing its volume. The compressor unit may specifically be a positive displacement compressor which may be configured for compressing gas by a displacement of a mechanical linkage reducing the volume. Further, the compressor unit may be a dynamic compressor.

Further, the analyzer system may comprise at least one storage pressure tank syringe pump, specifically at least one motorized storage pressure tank syringe pump. The dopand gas supply, specifically the reaction vessel or the headspace gas extraction device, may be connected or connectable to the storage pressure tank syringe pump via at least one valve, specifically via at least one three way valve. The storage pressure tank syringe pump may be configured to be filled with the chemical dopand gas during generation of the chemical dopand gas. Further, the valve may be configured for connecting the storage pressure tank syringe pump with the gas supply, specifically with the nebulizer gas supply, specifically after filling. Specifically, the valve may be configured for connecting the storage pressure tank syringe pump with the tube of the gas supply, specifically of the nebulizer gas supply. More specifically, the valve may be configured for connecting the storage pressure tank syringe pump with a pressure regulator valve connected to the tube of the gas supply. The storage pressure tank syringe pump may be configured to compress the chemical dopand gas to a working pressure, specifically to a preset working pressure. Further, the storage pressure tank syringe pump may be configured for supplying the gas supply, specifically the nebulizer gas supply, more specifically the pressure regulator valve connected to the tube of the gas supply, with a steady source of the chemical dopand gas.

Further, the analyzer system may comprise at least one replenishing device, specifically at least one automated replenishing device. The replenishing device may be configured for, specifically continuously, filling or refilling the gas supply, specifically the headspace gas extraction device or the reaction vessel, with at least one substance. The substance may exemplarily be a precursor for the chemical dopand gas or may be or may comprise the chemical dopand in liquid or solid form. Specifically, the replenishing device may comprise at least one replenishing device storage tank. The replenishing device storage tank may be configured for storing the at least one substance such as the precursor or the chemical dopand in liquid or solid form. Further, the replenishing device may comprise at least one replenishing device pump which may specifically be configured for transferring the substance from the replenishing device storage tank to the gas supply. Further, the replenishing device may comprise at least one valve or at least one constraint capillary tube which may specifically be configured for dosing or regulating a flow of the substance into the gas supply. Thus, the replenishing device may be configured for permanently transferring the substance to the gas supply in order to keep a concentration of the chemical dopand gas constant. A pressure of the chemical dopand gas within the headspace of the headspace gas extraction device may be compensated by the replenishing device, specifically by the replenishing device pump. Thus, a liquid level within the headspace gas extraction device may be constant, while, at the same time, an unused solution of the chemical dopand may be available.

The analyzer system may specifically comprise at least two dopand gas supplies. The at least two dopand gas supplies may be configured for providing at least two chemical dopand gasses having at least two chemical dopands. The analyzer system may further comprise at least one mixing device. The mixing device may be configured for preparing a mixture of the at least two chemical dopand gasses. Further, the mixing device may be configured for preparing a mixture of the chemical dopand gas and a further gas. Further, the analyzer system may comprise at least one dosing device. The dosing device may be configured for dosing the dopand gas. The dosing device and the mixing device may be separated components. However, alternatively, the dosing device and the mixing device may be designed as integral unit. The mixing device and/or the dosing device may comprise at least one component selected from the group consisting of: a micro solenoid, specifically a 2/2 way micro solenoid, a 3/2 way micro solenoid; a membrane pump; a microdosing pump. Also other components may be feasible.

Further, the analyzer system may comprise at least one temperature control device. The temperature control device may be configured for controlling a temperature of one of: the gas provided by the gas supply; the chemical dopand gas provided by the dopand gas supply. Further, additionally or alternatively, the analyzer system may comprise at least one further temperature control device. The further temperature control device may be configured for controlling a temperature of the liquid provided by the liquid supply. Specifically, the liquid provided by the liquid supply may correspond to an eluate provided by the liquid chromatography device. By increasing a temperature of the gas provided by the gas supply, a temperature of the chemical dopand gas provided by the dopand gas supply and/or a temperature of the liquid provided by the liquid supply, signal enhancing reactions or noise suppressing reactions may be increased, specifically protonation or deprotonation of the analyte may be increased. Specifically, the temperature control device and/or the further temperature control device may be configured for one or more of measuring the temperature of the gas or the liquid, adjusting the temperature of the gas or the liquid. The temperature control device may comprise at least one component selected from the group consisting of: a tubular heater, a flow heater, a ceramic sectional heater, a screw-in heater, a heating flange. Further, the temperature control device may comprise at least one temperature sensor such as a thermocouple or a resistance temperature sensor configured for determining a temperature of the gas.

In a further aspect of the present invention, a multiplexing analyzer system is disclosed.

The term “multiplexing analyzer system” as used herein is a broad term and is to be given its ordinary and customary meaning to a person of ordinary skill in the art and is not to be limited to a special or customized meaning. The term specifically may refer, without limitation, to an arbitrary analyzer system which is configured for carrying out a plurality of analytical measurements with a plurality of samples wherein a conducting of the plurality of analytical measurements is performed sequentially and/or interleaved in time. Exemplarily, one first step of an analytical measurement of a first sample and one second step of an analytical measurement of a second sample may take place in parallel. The first step and the second step may specifically correspond to a different kind of steps of the analytical measurement. However, the first step and the second step may also correspond to the same kind of steps of the analytical measurement.

The multiplexing analyzer system comprises at least one mass spectrometry device having at least one electrospray ion source nozzle. Further, the multiplexing analyzer system comprises at least two, preferably at least three, liquid supplies. The liquid supplies are configured for providing at least one liquid having at least one analyte. Further, the multiplexing analyzer system comprises at least one gas supply. The gas supply is configured for providing at least one gas. The gas supply is coupled to the mass spectrometry device via the electrospray ion source nozzle. Further, the multiplexing analyzer system comprises at least one dopand gas supply. The dopand gas supply is configured for providing at least one chemical dopand gas having at least one chemical dopand to the analyte provided by one of the two liquid supplies. The dopand gas supply is connected to the gas supply. The liquid supplies are alternately couplable to the mass spectrometry device via the electrospray ion source nozzle. Specifically, each of the liquid supplies may respectively have at least one liquid supply line such as at least one liquid supply tube which may be connected or connectable to the capillary of the electrospray ion source nozzle. Further, each of the liquid supply lines may respectively have at least one liquid supply valve. The liquid supply valve may have or may comprise at least one locking piece which may be moveable into at least two different positions. In a first position, the locking piece may be arranged within the liquid supply valve such that a connection between one part of the liquid supply line and a further part of the liquid supply line emerges. Thus, a connection between the liquid supply and the capillary of the electrospray ion source nozzle may emerge. Further, in a second position, the locking piece may be arranged within the liquid supply valve such that the one part of the liquid supply line and the further part of the liquid supply line are disconnected from each other. Thus, the liquid supply and the capillary of the electrospray ion source nozzle may be disconnected from each other.

Specifically, the multiplexing analyzer system may comprise at least two dopand gas supplies, preferably at least three dopand gas supplies. The at least two dopand gas supplies may be alternately couplable to the mass spectrometry device via the electrospray ion source nozzle. As outlined above, the dopand gas supply may comprise the dopand gas supply line. Specifically, each of the dopand gas supplies may respectively comprise a dopand gas supply line. Specifically, each of the dopand gas supplies may respectively have at least one dopand gas supply line such as at least one dopand gas supply tube which may respectively be connected or connectable to a further dopand gas supply line. The further dopand gas supply line may lead to the end or to the tip of the capillary. Further, each of the dopand gas supply lines may respectively have at least one dopand gas supply valve. The dopand gas supply valve may have or may comprise at least one locking piece which may be moveable into at least two different positions. In a first position, the locking piece may be arranged within the dopand gas supply valve such that a connection between the dopand gas supply line and the further dopand gas supply line emerges. Thus, a connection between the dopand gas supply and the electrospray ion source nozzle may emerge. Further, in a second position, the locking piece may be arranged within the dopand gas supply valve such that the dopand gas supply line and the further dopand gas supply line may be disconnected. Thus, the dopand gas supply and the electrospray ion source nozzle may be disconnected from each other.

With regard to the mass spectrometry device, the liquid supply, the gas supply and the dopand gas supply, reference may be made to the description above. Further, the multiplexing analyzer system may comprise components of the analyzer system such as the mixing device, the dosing device and/or the temperature control device. Reference with regard to these components may be made to the description above.

In a further aspect of the present invention, a use of an analyzer system as described above or as will further be described below in more detail for a detection of at least one steroid or a metabolite thereof, specifically of estradiol, is disclosed.

In a further aspect of the present invention, a method for analyzing at least one analyte is disclosed.

The method comprises the following steps which specifically may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) providing at least one analyzer system as described above or as will further be described below in more detail;
b) providing the liquid having the analyte and providing the gas to the electrospray ion source nozzle;
c) providing the chemical dopand gas having the chemical dopand via the gas supply thereby supporting a protonation or a deprotonation of the analyte; and
d) conducting at least one measurement with the mass spectrometry device.

For further details, definitions or options of the method steps, reference may be made to the analyzer system as described above or as described in further details below.

The methods and devices according to the present invention provide a large number of advantages over known methods and devices.

Specifically, an electrospray ionization negative mode sensitivity may increase. Further, an introduction of a post column peak dispersion volume may be avoided. Moreover, the method for analyzing the at least one analyte as well as the analyzer system itself may have a low level of complexity. Further, the method for analyzing the at least one analyte as well as the analyzer system may principally be robust against acidic contaminations such as formic acid, specifically through a basic nature of the chemical dopand.

The nebulizer gas may be doped with a gaseous dopand capable of enhancing a signal-to-noise ratio either by increasing a signal of the analyte of interest, suppressing background signals or by both of the aforementioned modes of operation simultaneously during electrospray ionization or other ambient pressure ionization techniques. The dopand gas may be supplied from a pressurized gas bottle or may be produced in situ by extraction from a solution via headspace extraction or via direct bubbling extraction from a liquid solution of the dopand gas, or alternatively by releasing the dopand gas from an amenable solid or liquid either by releasing evaporating physical bound/adsorbed gas or by chemical decomposition of a precursor chemical by heat introduced e.g. by heated gas, direct heating by heating element or laser energy coupling to the surface. Examples for the sources of dopand gas of the aforementioned processes may be e.g. ammonia as pressurized gas or solution, or salts thereof, especially carbonate, fluoride, formate, acetate decomposed by the mentioned heating or decomposition methods. Some embodiments of this invention may principally omit a need for pressurized gas containers by replacing with an in situ generation unit, circumventing safety and regulatory concerns. An application of the chemical dopand in gaseous form, such as by utilizing ammonia gas, may lead to short cycle times due to its volatile character.

Summarizing and without excluding further possible embodiments, the following embodiments may be envisaged:

Embodiment 1: An analyzer system, wherein the analyzer system comprises:
at least one mass spectrometry device having at least one electrospray ion source nozzle;
at least one liquid supply, wherein the liquid supply is configured for providing at least one liquid having at least one analyte;
at least one gas supply, wherein the gas supply is configured for providing at least one gas; and
at least one dopand gas supply, wherein the dopand gas supply is configured for providing at least one chemical dopand gas having at least one chemical dopand to the analyte provided by the liquid supply;
   wherein the liquid supply and the gas supply are coupled to the mass spectrometry device via the electrospray ion source nozzle, wherein the dopand gas supply is connected to the gas supply.

Embodiment 2: The analyzer system according to the preceding embodiment, wherein the gas supply is a nebulizer gas supply, wherein the nebulizer gas supply is configured for providing at least one nebulizer gas, wherein the nebulizer gas is configured for nebulizing the liquid provided by the liquid supply.

Embodiment 3: The analyzer system according the preceding embodiment, wherein the dopand gas supply is connected to the nebulizer gas supply.

Embodiment 4: The analyzer system according to any one of the two preceding embodiments, wherein the nebulizer gas comprises at least one inert gas, specifically at least one of nitrogen, argon, helium.

Embodiment 5: The analyzer system according to any one of the preceding embodiments, wherein the analyzer system further comprises at least one heated gas supply, wherein the heated gas supply is configured for providing at least one heated gas to the electrospray ion source nozzle.

Embodiment 6: The analyzer system according the preceding embodiment, wherein the dopand gas supply is connected to the heated gas supply.

Embodiment 7: The analyzer system according to any one of the two preceding embodiments, wherein the heated gas comprises at least one inert gas, specifically at least one of nitrogen, argon, helium.

Embodiment 8: The analyzer system according to any one of the preceding embodiments, wherein the chemical dopand gas is ammonia.

Embodiment 9: The analyzer system according to any one of the preceding embodiments, wherein at least one raw material for a formation of the chemical dopand gas is selected from the group consisting of: ammonium carbonate, ammonium fluoride, ammonium acetate, ammonium methanoate.

Embodiment 10: The analyzer system according to any one of the preceding embodiments, wherein the analyzer system comprises at least one liquid chromatography device, wherein the liquid supply is coupled to the liquid chromatography device.

Embodiment 11: The analyzer system according to the preceding embodiment, wherein the liquid chromatography device is selected from the group consisting of: a nano-liquid chromatography device, a micro-liquid chromatography device, a rapid liquid chromatography device, a high-performance liquid chromatography device.

Embodiment 12: The analyzer system according to any one of the preceding embodiments, wherein the analyte is a steroid or a metabolite thereof, specifically estradiol.

Embodiment 13: The analyzer system according to any one of the preceding embodiments, wherein the analyzer system is an in vitro diagnostic analyzer.

Embodiment 14: The analyzer system according to any one of the preceding embodiments, wherein the dopand gas supply comprises at least one dopand gas flask comprising the chemical dopand, wherein the dopand gas flask is connected to the gas supply.

Embodiment 15: The analyzer system according to the preceding embodiment, wherein the dopand gas flask is connected to the gas supply via at least one t-piece, wherein the dopand gas supply further comprises at least one valve, wherein the valve is configured for regulating a flow of the chemical dopand into the gas supply.

Embodiment 16: The analyzer system according to any one of the two preceding embodiments, wherein the dopand gas flask comprises the chemical dopand as pressurized gas.

Embodiment 17: The analyzer system according to any one of the preceding embodiments, wherein the dopand gas supply comprises at least one headspace gas extraction device, wherein the headspace gas extraction device is configured for providing a gas comprising the chemical dopand in gaseous form, wherein the headspace gas extraction device is connected to the gas supply.

Embodiment 18: The analyzer system according to the preceding embodiment, wherein the analyzer system comprises at least one supply line for supplying gas from the gas supply to the headspace gas extraction device, wherein the analyzer system further comprises at least one further supply line for supplying gas from the headspace gas extraction device to the gas supply.

Embodiment 19: The analyzer system according to any one of the two preceding embodiments, wherein the headspace gas extraction device comprises a solution of the chemical dopand, wherein the headspace gas extraction device is configured for extracting the chemical dopand in gaseous form from a gas head space.

Embodiment 20: The analyzer system according to the preceding embodiment, wherein the headspace gas extraction device is configured for impinging the gas of the gas supply with the chemical dopand.

Embodiment 21: The analyzer system according to any one of the four preceding embodiments, wherein the headspace gas extraction device comprises at least one reaction vessel, wherein the reaction vessel is configured for receiving at least one ammonium salt, wherein the headspace gas extraction device further comprises at least one reaction vessel supply to the reaction vessel, wherein the reaction vessel supply is configured for providing at least one reaction solution to the reaction vessel.

Embodiment 22: The analyzer system according to the preceding embodiment, wherein the reaction vessel supply comprises at least one pump, wherein the pump is configured for dosing a flow of the reaction solution into the reaction vessel.

Embodiment 23: The analyzer system according to any one of the two preceding embodiments, wherein the ammonia salt is selected from the group consisting of: ammonium sulfate, ammonium nitrate, ammonium methanoate, ammonium acetate, ammonium carbonate.

Embodiment 24: The analyzer system according to any one of the three preceding embodiments, wherein the reaction solution is selected from the group consisting of: a solution of sodium hydroxide; a solution of potassium hydroxide.

Embodiment 25: The analyzer system according to any one of the four preceding embodiments, wherein the analyzer system further comprises at least one syringe pump, specifically at least one motorized syringe pump, wherein the analyzer system further comprises at least one three-way valve, wherein the three-way valve is configured for electively connecting the syringe pump to the reaction vessel and to the gas supply, wherein, during reaction, the syringe pump is connected to the reaction vessel and is configured to be filled with a chemical dopand gas and wherein after reaction, the syringe pump is connected to the gas supply and is configured for providing the chemical dopand gas to the gas supply.

Embodiment 26: The analyzer system according to the preceding embodiment, wherein the analyzer system further comprises at least one pressure regulator valve, wherein the pressure regulator valve connects the syringe pump to the gas supply.

Embodiment 27: The analyzer system according to any one of the two preceding embodiments, wherein the headspace gas extraction device is connected to the syringe pump via at least one three-way-valve, wherein the syringe pump is configured to be filled with a chemical dopand gas during reaction.

Embodiment 28: The analyzer system according to any one of the eleven preceding embodiments, wherein the chemical dopand is provided as solid substance.

Embodiment 29: The analyzer system according to the preceding embodiment, wherein the headspace gas extraction device is configured for impinging the solid substance with the gas of the gas supply.

Embodiment 30: The analyzer system according to any one of the two preceding embodiments, wherein the headspace gas extraction device comprises at least one gas heating unit, wherein the gas heating unit is configured for heating the gas provided by the gas supply, specifically before the gas is impinged on the solid substance.

Embodiment 31: The analyzer system according to any one of the three preceding embodiments, wherein the headspace gas extraction device comprises at least one laser ablation device, wherein the laser ablation device is configured for ablating the solid substance.

Embodiment 32: The analyzer system according to any one of the four preceding embodiments, wherein the solid substance is selected from the group consisting of: ammonium methanoate, ammonium acetate, ammonium carbonate.

Embodiment 33: The analyzer system according to any one of the sixteen preceding embodiments, wherein the analyzer system further comprises at least one storage tank, specifically at least one storage pressure tank, wherein the storage tank is configured for storing the gas comprising the chemical dopand in gaseous form.

Embodiment 34: The analyzer system according to the preceding embodiment, wherein the analyzer system further comprises at least one compressor unit configured for compressing the gas comprising the chemical dopand in gaseous form.

Embodiment 35: The analyzer system according to any one of the two preceding embodiments, wherein the analyzer system further comprises at least one dosage gas regulator, wherein the dosage gas regulator is configured for connecting the gas supply to the storage tank.

Embodiment 36: The analyzer system according to any one of the preceding embodiments, wherein the liquid supply comprises at least one liquid supply syringe pump configured for dosing a flow of the liquid having the at least one analyte into the liquid supply.

Embodiment 37: The analyzer system according to any one of the preceding embodiments, wherein the analyzer system comprises at least two dopand gas supplies, wherein the at least two dopand gas supplies are configured for providing at least two chemical dopand gasses having at least two chemical dopands, wherein the analyzer system further comprises at least one mixing device, wherein the mixing device is configured for preparing a mixture of the at least two chemical dopand gasses.

Embodiment 38: The analyzer system according to any one of the preceding embodiments, wherein the analyzer system further comprises at least one dosing device, wherein the dosing device is configured for dosing the dopand gas.

Embodiment 39: A multiplexing analyzer system, wherein the multiplexing analyzer system comprises:
at least one mass spectrometry device having at least one electrospray ion source nozzle;
at least two, preferably at least three, liquid supplies, wherein the liquid supplies are configured for providing at least one liquid having at least one analyte;
at least one gas supply, wherein the gas supply is configured for providing at least one gas, wherein the gas supply is coupled to the mass spectrometry device via the electrospray ion source nozzle; and
at least one dopand gas supply, wherein the dopand gas supply is configured for providing at least one chemical dopand gas having at least one chemical dopand to the analyte provided by one of the two liquid supplies, wherein the dopand gas supply is connected to the gas supply;
   wherein the liquid supplies are alternately couplable to the mass spectrometry device via the electrospray ion source nozzle.

Embodiment 40: The multiplexing analyzer system according to the preceding embodiment, wherein the multiplexing analyzer system comprises at least two dopand gas supplies, preferably at least three dopand gas supplies, wherein the two dopand gas supplies are alternately couplable to the mass spectrometry device via the electrospray ion source nozzle.

Embodiment 41: Use of an analyzer system according to any one of the preceding embodiments referring to an analyzer system for a detection of at least one steroid or a metabolite thereof, specifically of estradiol.

Embodiment 42: Method for analyzing at least one analyte, wherein the method comprises:
a) providing at least one analyzer system according to any one of the preceding embodiments referring to an analyzer system;
b) providing the liquid having the analyte and providing the gas to the electrospray ion source nozzle;
c) providing the chemical dopand gas having the chemical dopand via the gas supply thereby supporting a protonation or a deprotonation of the analyte; and
d) conducting at least one measurement with the mass spectrometry device.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A to 1C show exemplary embodiments of an analyzer system according to the present invention;

FIG. 2 shows a chromatogram illustrating a proof-of-concept experiment;

FIG. 3 shows a chromatogram illustrating a further proof-of-concept experiment;

FIG. 4 shows an exemplary embodiment of a multiplexing analyzer system according to the present invention; and

FIG. 5 schematically shows a method for analyzing at least one sample with the multiplexing system according to the present invention.

### DETAILED DESCRIPTION OF THE EMBODIMENTS

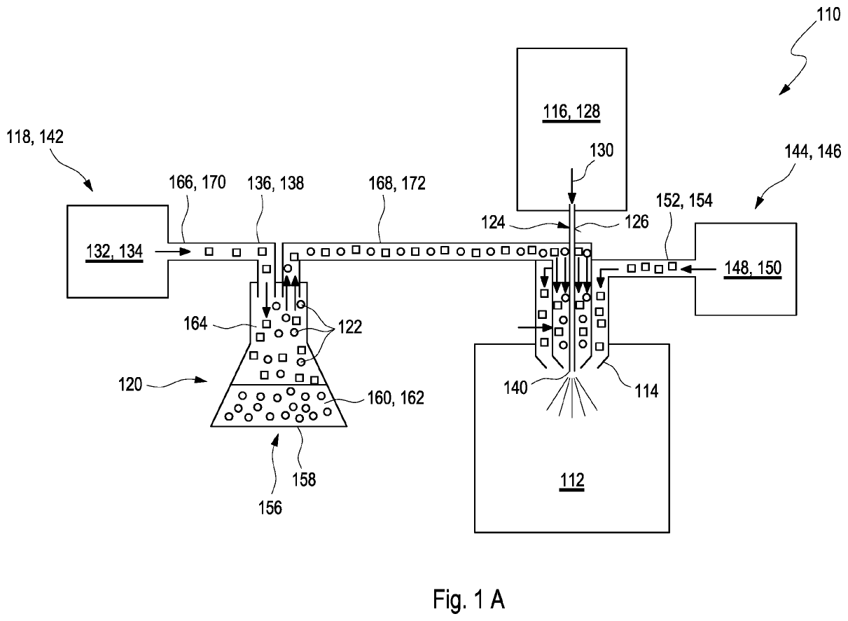

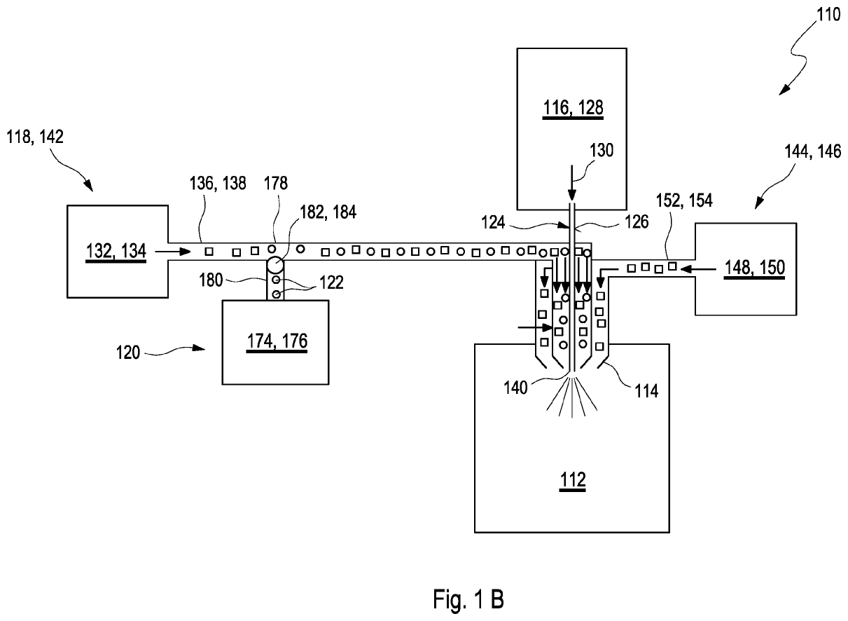

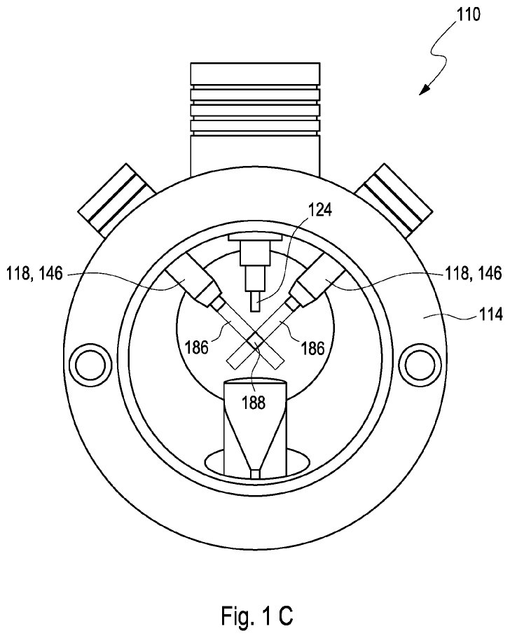

FIGS. 1A to 1C show exemplary embodiments of an analyzer system 110 according to the present invention. The analyzer system 110 comprises at least one mass spectrometry device 112 having at least one electrospray ion source nozzle 114. Further, the analyzer system 110 comprises at least one liquid supply 116. The liquid supply 116 is configured for providing at least one liquid having at least one analyte. Further, the analyzer system comprises at least one gas supply 118. The gas supply 118 is configured for providing at least one gas. Further, the analyzer system 110 comprises at least one dopand gas supply 120. The dopand gas supply 120 is configured for providing at least one chemical dopand gas having at least one chemical dopand 122 to the analyte provided by the liquid supply 116. The liquid supply 116 and the gas supply 118 are coupled to the mass spectrometry device 112 via the electrospray ion source nozzle 114 and the dopand gas supply 120 is connected to the gas supply 118.

As illustrated in FIGS. 1A and 1B, the electrospray ion source nozzle 114 may comprise at least one capillary 124. The capillary 124 may exemplarily be made of glass and/or at least one metal such as stainless steel. The electrospray ion source nozzle 114 may be configured to apply a high voltage on an outer surface 126 of the capillary 124. Specifically, the liquid supply 116 may be or may correspond to a liquid chromatography device 128. The capillary 124 of the electrospray ion source nozzle 114 may be coupled or couplable to the liquid supply 116, specifically to the liquid chromatography device 128 via at least one tube or the like as schematically indicated with arrow 130.

Further, as illustrated in FIGS. 1A and 1B, the gas supply 118 may comprise at least one storage element 132 such as a container 134 configured for providing and storing the gas. Further, the gas supply 118 may comprise at least one tube 136 such as at least one hose 138. Specifically, the gas supply 118 may comprise the at least one tube 136 and the tube 136 may lead to an end 140 of the capillary 124.

Specifically, the gas supply may be a nebulizer gas supply 142. The nebulizer gas supply 142 may be configured for providing at least one nebulizer gas. The nebulizer gas may be configured for nebulizing the liquid provided by the liquid supply 116. Specifically, the nebulizer gas 142 may comprise at least one inert gas, specifically nitrogen. Further, the analyzer system may comprise at least one further gas supply 144. The further gas supply may be a heated gas supply 146. The heated gas supply 146 may be configured for providing at least one heated gas to the electrospray ion source nozzle 114. Specifically, the heated gas may comprise at least one inert gas, specifically nitrogen. The heated gas supply 146 may comprise at least one further storage element 148 such as a further container 150 configured for providing and storing the gas. Further, the heated gas supply 146 may comprise at least one further tube 152 such as at least one further hose 154. Specifically, the heated gas supply 146 may comprise the at least one further tube 152 and the further tube 152 may lead to the end 140 of the capillary 124. Exemplarily, as illustrated in FIG. 1A, the analyzer system 110 may comprise the nebulizer gas supply 142 and the heated gas supply 146. Further, as illustrated in FIG. 1A, the dopand gas supply 120 may be connected to the nebulizer gas supply 142.

Specifically, as illustrated in FIG. 1A, the dopand gas supply 120 may comprise at least one headspace gas extraction device 156. The headspace gas extraction device 156 may specifically comprise at least one container 158. The container 158 may be configured for receiving at least one substance, specifically at least one volatile substance, which may be in gaseous state or which may be brought in gaseous state. The headspace gas extraction device 156 may specifically comprise at least one solution 160 of the chemical dopand 122. The solution 160 of the chemical dopand 122 may specifically be a volatile solution 162. The headspace gas extraction device 156 may be configured for extracting the chemical dopand 122 in gaseous form from a gas headspace 164.

The headspace gas extraction device 156 may be connected or may be connectable to the gas supply 118, specifically to the nebulizer gas supply 142. Specifically, the analyzer system 110 may comprise at least one supply line 166 for supplying gas from the gas supply 118, specifically from the nebulizer gas supply 142, to the headspace gas extraction device 156. Further, the analyzer system 110 may comprise at least one further supply line 168 for supplying gas from the headspace gas extraction device 156 to the gas supply 118, specifically to the nebulizer gas supply 142. The supply line 166 may also be referred to as inlet 170 and the further supply line 168 may also be referred to as outlet 172.

A chemical dopand comprising nebulizer gas may meet an eluate provided by the liquid chromatography device 128 at the end 140 of the capillary 124. A homogenous mixing with the eluate may occur. The chemical dopand 122 may be configured for supporting a deprotonation in an electrospray ionization negative mode or a protonation in an electrospray ionization positive mode.

Alternatively, as illustrated in FIG. 1B, the dopand gas supply 120 may comprise at least one dopand gas flask 174 comprising the chemical dopand gas 122. The dopand gas flask 174 may specifically be a pressure stable bottle 176. Specifically, the dopand gas flask 174 may comprise the chemical dopand 122 as pressurized gas. The dopand gas flask 174 may be connected or may be connectable to the gas supply 118, specifically to the nebulizer gas supply 142. Specifically, the dopand gas flask 174 may be connected or may be connectable to the gas supply 118 via at least one t-piece 178. Specifically, the dopand gas flask 174 may be connected to at least one tube 180 and the tube 180 may be connected to the tube 136 of the gas supply 118 via the t-piece 178. Further, the dopand gas supply 120 may comprise at least one gas flow regulator 182, specifically at least one valve 184. The gas flow regulator 182 may be configured for regulating a flow of the chemical dopand 122 into the gas supply 118, specifically into the tube 136 of the gas supply 118. The t-piece may be configured for mixing the chemical dopand gas with the nebulizer gas.

FIG. 1C shows a detailed view of an exemplary embodiment of an analyzer system 110 according to the present invention. The electrospray ion source nozzle 114 having the at least one capillary 124 is depicted. Further, the heated gas supply 146 is illustrated. A mixture of the dopand chemical gas with the heated gas may be transferred to the electrospray ion source nozzle 114 from outside as depicted by the bars 186 meeting with ion spray at point 188. An outlet of the heated gas supply 146 may be arranged at an angle α of 20° to 80°, specifically of 30° to 70°, more specifically of 45°, to the capillary 124. A mixture of the chemical dopand gas with the heated gas may result in an optimized electrospray ionization process.

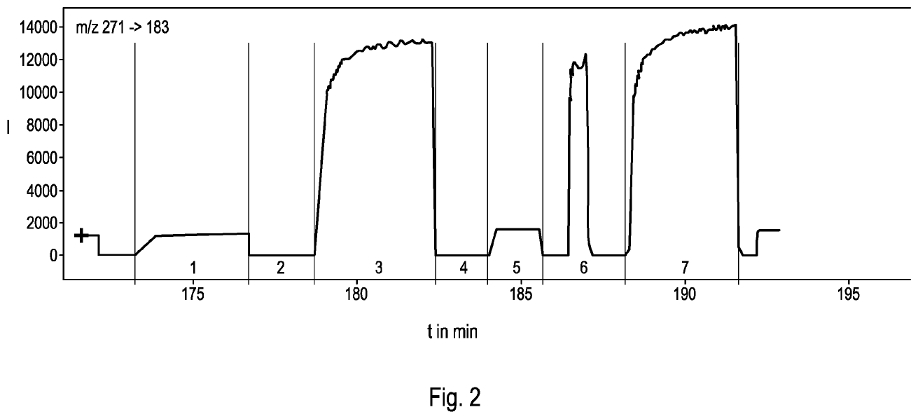

FIG. 2 shows a chromatogram illustrating a proof-of-concept experiment. The analyte Estradiol was infused directly into the mass spectrometry device using a syringe pump. The numbered parts of the chromatogram represent different parts of the experiments and are described as follows. In the chromatogram an intensity I is shown in dependence of the time t.

In section 1 of the chromatogram, the syringe pump was activated and the infusion of the analyte Estradiol was started. A signal increase was observed, stabilizing after a few seconds into a plateau. The intensity level of the plateau was about 1400.

In section 2 of the chromatogram, the syringe pump was switched off and an immediate decrease of the signal was observed, as the analyte was not infused anymore. The pressure stable bottle comprising a solution of ammonium hydroxide was connected to the mass spectrometry device.

In section 3 of the chromatogram, the syringe pump was turned on again and a signal increase was observed which stabilized after several seconds into a plateau with the intensity of about 13000. This equates to a signal enhancement of roughly a factor 9 by using the chemical dopand.

In section 4 of the chromatogram, the syringe pump was switched off and an immediate decrease of the signal was observed, as the analyte was not infused anymore.

In section 5 of the chromatogram, the pressure stable bottle comprising the solution of ammonium hydroxide was disconnected from the mass spectrometry device and the syringe pump turned on again. A signal increase was observed which stabilized after several seconds into a plateau with the intensity of about 1600. The experiment showed results comparable to section 1.

In section 6 of the chromatogram, the syringe pump was turned on again and a signal increase was observed. The signal was not able to stabilize into a plateau as the syringe pump emptied. Thus, the syringe pump was switched off and was refilled manually.

In section 7 of the chromatogram, the syringe pump was turned on again and a signal increase was observed which stabilized after several seconds into a plateau with the intensity of about 14000. The experiment results may be comparable to section 3.

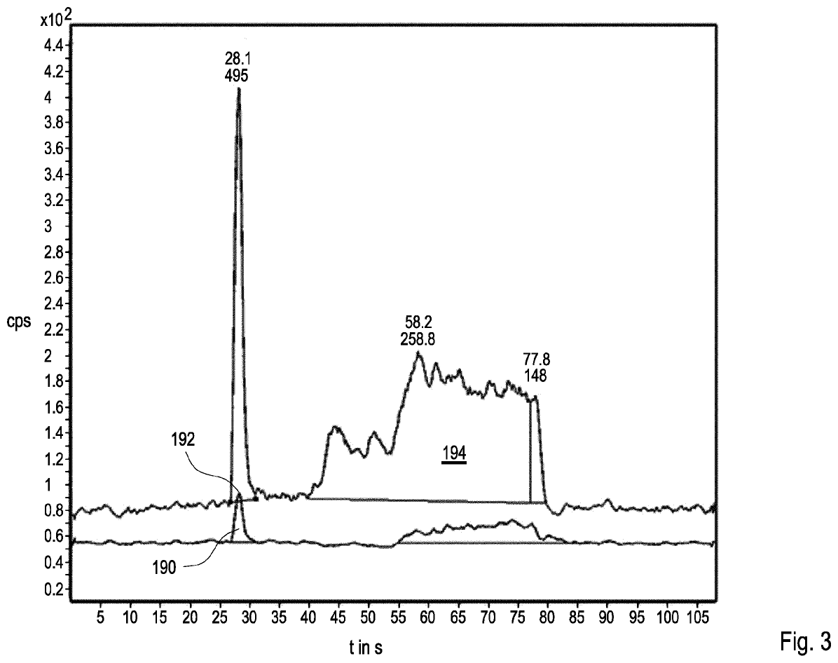

FIG. 3 shows a chromatogram illustrating a further proof-of-concept experiment. To investigate the signal enhancement on a liquid chromatography mass spectrometry based assay, an Agilent 1290 Infinity HPLC system was connected to the Agilent 6495 Triple Quadrupole. In the chromatogram counts per second cps are illustrated in dependence of the retention time t.

The chromatogram 190 shows the injection of a 100 pg/mL Estradiol calibrator dissolved in neat solvent and ran with eluent A comprising deionized water, LC/MS grade, and eluent B comprising 0.2 mmol/L ammonium fluoride in methanol. The neat solvent may refer to a standard solvent, LC/MS grade, which may specifically be neat in such a way that effects on the signal, specifically matrix effects on the signal, are avoided or at least reduced to a large extent. This mobile phase composition represents the state-of-the-art of an Estradiol assay. The Estradiol peak 192 eluted at a retention time of 28 s and showed an area value of 59. For preparing the chromatogram 194 gaseous ammonium hydroxide addition as dopand was utilized. The mobile phase was eluent A comprising LC/MS grade water and eluent B comprising methanol. The retention time of Estradiol was 28 s with an area value of 495. This represents a signal enhancement of roughly a factor 8 compared to a state-of-the-art Estradiol assay.

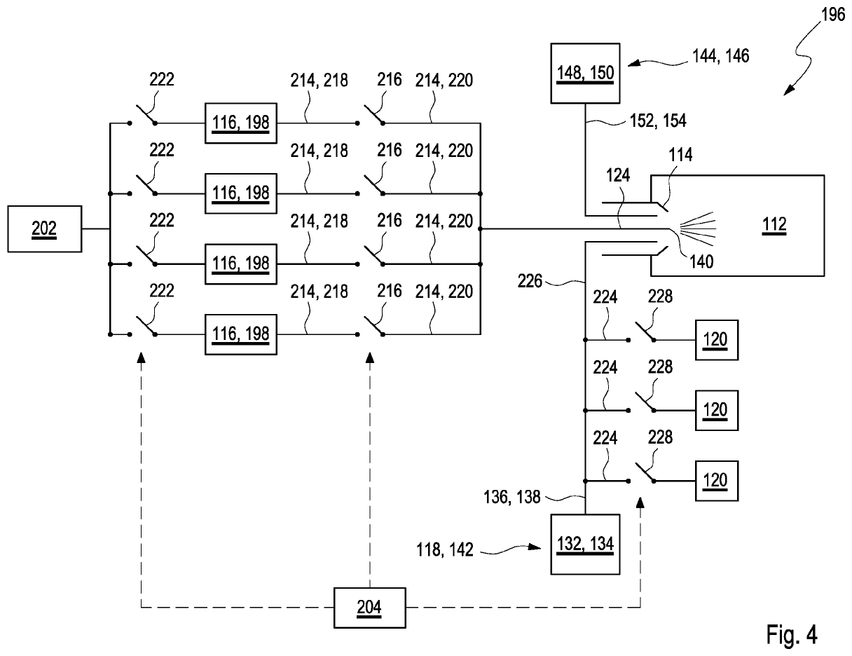

FIG. 4 shows an exemplary embodiment of a multiplexing analyzer system 196 according to the present invention.

The multiplexing analyzer system 196 comprises the at least one mass spectrometry device 112 having the at least one electrospray ion source nozzle 114. Further, the multiplexing analyzer system 196 comprises at least two, preferably at least three, of the liquid supplies 116. In the embodiment according to FIG. 4, the multiplexing analyzer system 196 may comprise at least four of the liquid supplies 116. Specifically, three of the four liquid supplies 116 may be high pressure liquid chromatography (HPLC) devices 198 and one of the four liquid supplies 116 may be a rapid liquid chromatography device 200. The liquid supplies 116 are alternately couplable to the mass spectrometry device 112 via the electrospray ion source nozzle 114. Specifically, each of the liquid supplies 116 may respectively have at least one liquid supply line 214 which may be connected or connectable to the capillary 124 of the electrospray ion source nozzle 114. Further, each of the liquid supply lines 214 may respectively have at least one liquid supply valve 216. The liquid supply valve 216 may have or may comprise at least one locking piece which may be moveable into at least two different positions. In a first position, the locking piece may be arranged within the liquid supply valve 216 such that a connection between one part 218 of the liquid supply line 214 and a further part 220 of the liquid supply line 214 emerges. Thus, a connection between the liquid supply 116 and the capillary 124 of the electrospray ion source nozzle 114 may emerge. Further, in a second position, the locking piece may be arranged within the liquid supply valve 216 such that the one part 218 of the liquid supply line 214 and the further part 220 of the liquid supply line 214 are disconnected from each other. Thus, the liquid supply 116 and the capillary 124 of the electrospray ion source nozzle 114 may be disconnected from each other. The liquid supplies 116 may be alternately couplable to a container 202 providing at least one sample. Specifically, the liquid supplies 116 may respectively be alternately couplable to the container 202 via at least one valve 222.

Further, the multiplexing analyzer system 196 comprises the at least one gas supply 118. The gas supply 118 is configured for providing at least one gas such as nitrogen. The gas supply 118 is coupled to the mass spectrometry device 112 via the electrospray ion source nozzle 114. Further, the multiplexing analyzer system 196 comprises the at least one dopand gas supply 120. Specifically, the multiplexing analyzer system 196 may comprise at least three of the dopand gas supplies 120. The at least three dopand gas supplies 120 may be alternately connectable to the gas supply 118. Specifically, each of the dopand gas supplies 120 may respectively comprise a dopand gas supply line 224. Specifically, each of the dopand gas supplies 120 may respectively have at least one dopand gas supply line 224 which may respectively be connected or connectable to a further dopand gas supply line 226. The further dopand gas supply line 226 may lead to the end 140 of the capillary 124.

Further, each of the dopand gas supply lines 224 may respectively have at least one dopand gas supply valve 228. The dopand gas supply valve 228 may have or may comprise at least one locking piece which may be moveable into at least two different positions. In a first position, the locking piece may be arranged within the dopand gas supply valve 228 such that a connection between the dopand gas supply line 224 and the further dopand gas supply line 226 emerges. Thus, a connection between the dopand gas supply 120 and the electrospray ion source nozzle 114 may emerge. Further, in a second position, the locking piece may be arranged within the dopand gas supply valve 228 such the that dopand gas supply line 224 and the further dopand gas supply line 226 may be disconnected. Thus, the dopand gas supply 120 and the electrospray ion source nozzle 114 may be disconnected from each other. Further, the multiplexing analyzer system 196 may comprise at least one controller 204. The controller 204 may be configured for controlling at least one of the liquid supply valve 216, the valve 222, the dopand gas supply valve 228. Further, optionally, the multiplexing analyzer system 196 may comprise the heated gas supply 146.

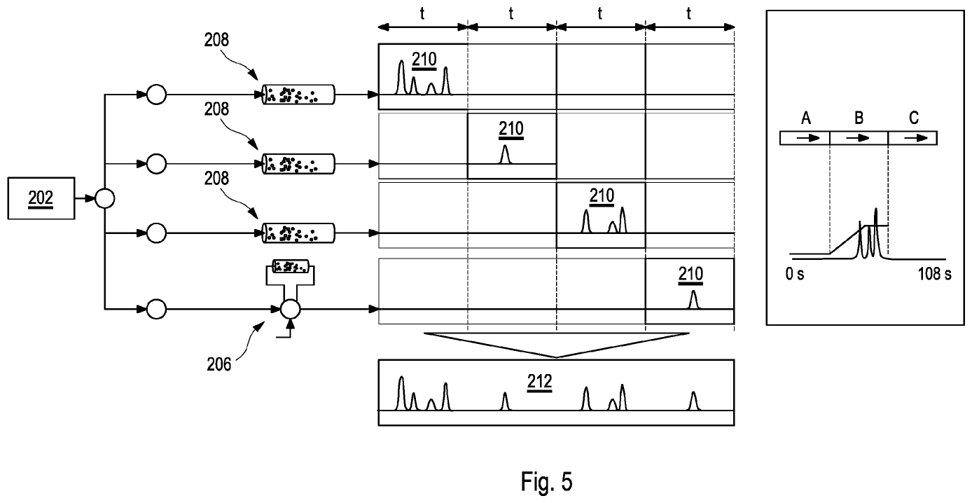

In FIG. 5 a method for analyzing at least one sample with the multiplexing system 196 is depicted schematically.

Three high pressure liquid chromatography (HPLC) streams 206 and one rapid liquid chromatography stream 208 may be multiplexed and may be directed alternately into the mass spectrometry device 112 which may specifically be kept constantly in a random access measurement mode. Mass spectra 210 may be obtained successively during a time period 1. The time period/may exemplary be 36 s. Thus, mass spectrometric data 212 may be collected. A liquid chromatography mass spectrometric cycle may specifically comprise three phases, an equilibrium phase A, a detection phase B and a cleaning phase (′ such as illustrated in the right casket. While one of the HPLC streams 206 may be in the equilibrium phase, one of the other HPLC streams 206 may be in the detection phase and one of the other HPLC streams 206 may be in the cleaning phase and vice versa. The chemical dopand gas may be specifically and selectively only provided during the detection phase B.

The challenge for a detector of the mass spectrometry device may be the fast switching of mobile phases with changes in pH, buffers and organic content. The addition of a gaseous dopand facilitates random access as the buffers and/or the pH changes may happen post-column only in the electrospray ion source nozzle source without the need to exchange buffers and pH for the whole flow path of the HPLC system. Therefore a faster switching and equilibration of mass spectrometric conditions may be possible, enabling robust high throughput analysis.

### LIST OF REFERENCE NUMBERS

110 analyzer system
112 mass spectrometry device
114 electrospray ion source nozzle
116 liquid supply
118 gas supply
120 dopand gas supply
122 chemical dopand
124 capillary
126 outer surface
128 liquid chromatography device
130 arrow
132 storage element
134 container
136 tube
138 hose
140 end
142 nebulizer gas supply
144 further gas supply
146 heated gas supply
148 further storage element
150 further container
152 further tube
154 further hose
156 headspace gas extraction device
158 container
160 solution
162 volatile solution
164 gas headspace
166 supply line
168 further supply line
170 inlet
172 outlet
174 dopand gas flask
176 pressure stable bottle
178 t-piece
180 tube
182 flow regulator
184 valve
186 bar
188 point
190 chromatogram
192 peak
194 chromatogram
196 multiplexing analyzer system
198 high pressure liquid chromatography device
200 rapid liquid chromatography device
202 container
204 controller
206 high pressure liquid chromatography stream
208 rapid liquid chromatography stream
210 mass spectrum
212 mass spectrometric data
214 liquid supply line
216 liquid supply valve
218 part
220 further part
222 valve
224 dopand gas supply line
226 further dopand gas supply line
228 dopand gas supply valve

1. An analyzer system, wherein the analyzer system comprises:
at least one mass spectrometry device having at least one electrospray ion source nozzle;
at least one liquid supply, wherein the liquid supply is configured for providing at least one liquid having at least one analyte;
at least one gas supply, wherein the gas supply is configured for providing at least one gas; and
at least one dopand gas supply, wherein the dopand gas supply is configured for providing at least one chemical dopand gas having at least one chemical dopand to the analyte provided by the liquid supply;
wherein the liquid supply and the gas supply are coupled to the mass spectrometry device via the electrospray ion source nozzle, wherein the dopand gas supply is connected to the gas supply.

2. The analyzer system according to claim 1, wherein the gas supply is a nebulizer gas supply, wherein the nebulizer gas supply is configured for providing at least one nebulizer gas, wherein the nebulizer gas is configured for nebulizing the liquid provided by the liquid supply.

3. The analyzer system according to claim 1, wherein the analyzer system further comprises at least one heated gas supply, wherein the heated gas supply is configured for providing at least one heated gas to the electrospray ion source nozzle.

4. The analyzer system according to claim 1, wherein the analyte is a steroid or a metabolite thereof.

5. The analyzer system according to claim 1, wherein the dopand gas supply comprises at least one dopand gas flask comprising the chemical dopand, wherein the dopand gas flask is connected to the gas supply.

6. The analyzer system according to claim 1, wherein the dopand gas supply comprises at least one headspace gas extraction device, wherein the headspace gas extraction device is configured for providing a gas comprising the chemical dopand in gaseous form, wherein the headspace gas extraction device is connected to the gas supply.

7. The analyzer system according to claim 6, wherein the headspace gas extraction device comprises a solution of the chemical dopand, wherein the headspace gas extraction device is configured for extracting the chemical dopand in gaseous form from a gas head space, wherein the headspace gas extraction device is configured for impinging the gas of the gas supply with the chemical dopand.

8. The analyzer system according to claim 6, wherein the headspace gas extraction device comprises at least one reaction vessel, wherein the reaction vessel is configured for receiving at least one ammonium salt, wherein the headspace gas extraction device further comprises at least one reaction vessel supply to the reaction vessel, wherein the reaction vessel supply is configured for providing at least one reaction solution to the reaction vessel.

9. The analyzer system according to preceding claim 6, wherein the chemical dopand is provided as solid substance, wherein the headspace gas extraction device is configured for impinging the solid substance with the gas of the gas supply.

10. The analyzer system according to claim 9, wherein the headspace gas extraction device comprises at least one gas heating unit, wherein the gas heating unit is configured for heating the gas provided by the gas supply before the gas is impinged on the solid substance.

11. The analyzer system according to claim 9, wherein the headspace gas extraction device comprises at least one laser ablation device, wherein the laser ablation device is configured for ablating the solid substance.

12. A multiplexing analyzer system, wherein the multiplexing analyzer system comprises:
at least one mass spectrometry device having at least one electrospray ion source nozzle;
at least two liquid supplies, wherein the liquid supplies are configured for providing at least one liquid having at least one analyte;
at least one gas supply, wherein the gas supply is configured for providing at least one gas, wherein the gas supply is coupled to the mass spectrometry device via the electrospray ion source nozzle; and
at least one dopand gas supply, wherein the dopand gas supply is configured for providing at least one chemical dopand gas having at least one chemical dopand to the analyte provided by one of the two liquid supplies, wherein the dopand gas supply is connected to the gas supply;
wherein the liquid supplies are alternately couplable to the mass spectrometry device via the electrospray ion source nozzle.

13. The multiplexing analyzer system according to claim 12, wherein the multiplexing analyzer system comprises at least two dopand gas supplies, wherein the two dopand gas supplies are alternately couplable to the mass spectrometry device via the electrospray ion source nozzle.

14. The analyzer system according to claim 4, wherein the analyte is estradiol.

15. A method for analyzing at least one analyte, wherein the method comprises:
a) providing at least one analyzer system according to claim 1;
b) providing the liquid having the analyte and providing the gas to the electrospray ion source nozzle;
c) providing the chemical dopand gas having the chemical dopand via the gas supply thereby supporting a protonation or a deprotonation of the analyte; and
d) conducting at least one measurement with the mass spectrometry device.
